(19) United States
(12) Patent Application Publication
(10) Pub. No.: US 2019/0004208 A1
(43) Pub. Date: Jan. 3, 2019

(54) SHORT DISTANCE ELECTROMAGNETIC COMMUNICATION FOR INSTRUMENTS IN ELECTRICALLY CONDUCTIVE HOUSINGS

(71) Applicant: Wolverine Oilfield Technologies, Houston, TX (US)

(72) Inventor: Bryan Gonsoulin, Houston, TX (US)

(21) Appl. No.: 16/021,635

(22) Filed: Jun. 28, 2018

Related U.S. Application Data
(60) Provisional application No. 62/528,291, filed on Jul. 3, 2017.

(51) Int. Cl. G01V 11/00; G01V 3/08

(52) U.S. Cl. CPC G01V 11/002; G01V 3/083

(57) ABSTRACT

An electromagnetic communication system for a wellbore drilling instrument includes a first antenna disposed in a pressure tight compartment in a wall of a drill collar or a pressure tight sonde and a second antenna disposed in a pressure tight sonde disposed in an interior passage in the drill collar or in a pressure tight compartment in a wall of the drill collar. A wall thickness of the drill collar and/or a wall thickness of the sonde, an electrically conductive material used for the drill collar and the sonde and a frequency of electromagnetic signals applied to at least one of the antennas are chosen to enable electromagnetic communication between the first antenna and the second antenna disposed.

### CROSS REFERENCE TO RELATED APPLICATIONS

Priority is claimed from U.S. Provisional Application No. 62/528,291 filed on Jul. 3, 2017, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of instruments used to make measurements of drilling parameters and/or formation parameters in wellbores drilled through subsurface formations. More specifically, the disclosure relates to communication devices for use in such instruments where housings for the instruments and related components are made from high strength, electrically conductive materials.

Measuring parameters related to wellbore drilling and/or properties of formations penetrated by drilling may be made during drilling using certain measuring instruments. Such measuring instruments are known in the art to be disposed in one or more “drill collars”, which are thick-walled tubular housings having connections for inclusion into a “drill string.” Such instruments may further include one or more sensors located externally to the drill collar. Such one or more sensors may comprise a data storage device or memory, and in some cases a short distance communication transceiver to communicate measurements and other data between the external sensor(s) and the measuring instrument disposed in a drill collar. One example of such a sensor and communication device is described in U.S. Pat. No. 5,813,480 issued to Zaleski, Jr. et al.

Communication devices such as the one described in the '480 patent use electromagnetic signals to transfer information between the external sensor(s) and the drill collar based measuring instrument(s). Antennas used in such communication devices may be disposed in a recess formed in the exterior surface of the drill collar and the instrument (e.g., a drill bit in the case of the device shown in the '480 patent). The recess may be covered on its exterior by an electrically non-conductive cover, e.g., made from glass fiber reinforced resin, or by a metal cover comprising openings therethrough to enable passage of electromagnetic energy through the cover. Irrespective of the type of cover used, the antennas in such communication devices are exposed, e.g., by being embedded in insulating material such as elastomer, to fluid in the wellbore. The fluid in the wellbore, which, depending on the vertical depth of the wellbore, the density of liquid (“drilling mud”) filling the wellbore and the pressure required to pump drilling mud through the wellbore and back to the surface, may exert substantial fluid pressure. Such pressure is known to breach pressure barriers, e.g., high pressure feed through bulkhead connectors, used to connect such antennas to electronic circuits disposed inside the drill collar and inside a housing or body for the external sensor(s).

### SUMMARY

An electromagnetic communication system for a wellbore instrument according to one aspect includes at least a first antenna disposed in either a pressure tight compartment in a wall of a drill collar or in a pressure tight sonde disposed in an interior passage in the drill collar. At least a second antenna is disposed in a pressure tight sonde disposed in either an interior passage within the drill collar or within a pressure tight compartment in the wall of the drill collar. A wall thickness of the drill collar and/or a wall thickness of the pressure tight sonde, an electrically conductive material used for the drill collar and/or the pressure tight sonde and a frequency of electromagnetic signals applied to at least one of the antennas are chosen to enable electromagnetic communication between the first antenna and the second antenna.

In some embodiments, the first antenna and the second antenna comprise coaxially wound coils.

In some embodiments, the antenna in the wall of the drill collar comprises a solenoid coil disposed on one side of the drill collar.

In some embodiments, a longitudinal axis of the antenna in the wall of the drill collar is oriented so that a magnetic dipole moment is parallel to a longitudinal axis of the drill collar.

In some embodiments, a longitudinal axis of the antenna in the wall of the drill collar is oriented so that a magnetic dipole moment is at an oblique angle to a longitudinal axis of the drill collar.

In some embodiments, at least one of the first antenna and the second antenna comprises a main coil and a longitudinal end coil disposed at each longitudinal end of the main coil.

In some embodiments, one of the first antenna and the second antenna comprises a magnetometer.

In some embodiments, the antenna in the wall of the drill collar comprises a saddle coil.

In some embodiments, the pressure tight sonde comprises a metal pressure barrel and an antenna cover disposed at one longitudinal end of the metal pressure barrel.

A method for electromagnetic communication according to another aspect includes conducting an electromagnetic signal to a transmitter antenna and detecting an electromagnetic signal induced in a receiver antenna by the electromagnetic signal conducted to the first transceiver antenna. At least one of the transmitter antenna and the receiver antenna is disposed in a pressure tight compartment in a wall of a drill collar or in a pressure tight sonde, and at least one of the receiver antenna and the transmitter antenna is disposed in a pressure tight sonde disposed in an interior passage in the drill collar or in a pressure tight compartment in a wall of the drill collar. A wall thickness of the drill collar and/or a wall thickness of the sonde, an electrically conductive material used for the drill collar and/or the sonde and a frequency of the electromagnetic signal conducted to the transmitter antenna are chosen to enable electromagnetic communication between the transmitter antenna and the receiver antenna.

In some embodiments, the antenna in the wall of the drill collar and/or the antenna in the sonde comprise coaxially wound coils.

In some embodiments, the antenna in the wall of the drill collar comprises a solenoid coil disposed on one side of the drill collar.

In some embodiments, a longitudinal axis of the antenna in the wall of the drill collar is oriented so that a magnetic dipole moment is parallel to a longitudinal axis of the drill collar.

The method of claim 12 wherein a longitudinal axis of the antenna in the wall of the drill collar is oriented so that a magnetic dipole moment is at an oblique angle to a longitudinal axis of the drill collar.

In some embodiments, at least one of the antenna in the wall of the drill collar and the antenna in the sonde comprises a main coil and a longitudinal end coil disposed at each longitudinal end of the main coil.

In some embodiments, the receiver antenna comprises a magnetometer.

In some embodiments, the antenna in the wall of the drill collar comprises a saddle coil.

In some embodiments, the sonde comprises a metal pressure barrel and an antenna cover disposed at one longitudinal end of the metal pressure barrel.

### BRIEF DESCRIPTION OF THE DRAWINGS

FIG. 1 shows schematically an example of communication between devices mounted in a drill collar and devices mounted in one or more “sondes”, i.e., pressure resistant housings, disposed in an internal passage inside a drill collar.

FIGS. 1A through 1D show different embodiments of a communication device.

FIG. 2 shows an example embodiment of transceiver antennas formed as wire coils wound about a longitudinal axis of a sonde and a drill collar.

FIG. 3 shows another example embodiment wherein the transceiver antenna in the drill collar is formed as a solenoid coil wound about an axis parallel to the longitudinal axis of the drill collar.

FIG. 4 shows another embodiment corresponding to the embodiment of FIG. 3 wherein the transceiver coil in the drill collar is oriented along an oblique axis.

FIG. 5 shows an example embodiment wherein the transceiver antenna in the sonde is substituted by a magnetometer.

FIG. 6 shows another example embodiment using a magnetometer in the sonde and wherein an antenna in the drill collar is formed as a saddle coil.

FIGS. 7A, 7B and 7C show response of a transceiver antenna pair for various relative locations between locations of the antennas with respect to the receiver.

FIG. 7D shows a graph of receiver response indicative of the fact that for certain longitudinal separation distances between the transceiver antenna in the drill collar and the transceiver antenna in the sonde, a “dead zone” exists.

FIG. 8 shows another example embodiment of transceiver antenna that can substantially eliminate the dead zone shown in FIG. 7D.

FIGS. 8A through 8C show responses of various longitudinal positions of the antennas with respect to each other.

FIG. 8D shows a graph similar to FIG. 7D wherein the dead zone of FIG. 7D is substantially eliminated.

FIG. 9 shows graphs of skin depth for various metals with respect to electromagnetic signal frequency.

### DETAILED DESCRIPTION

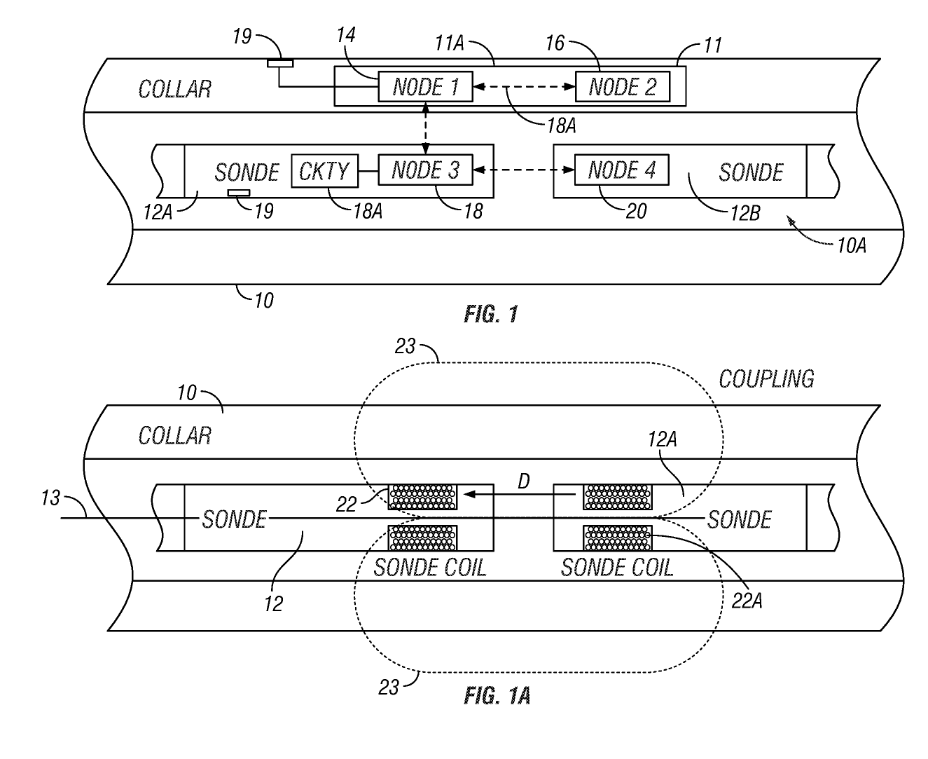

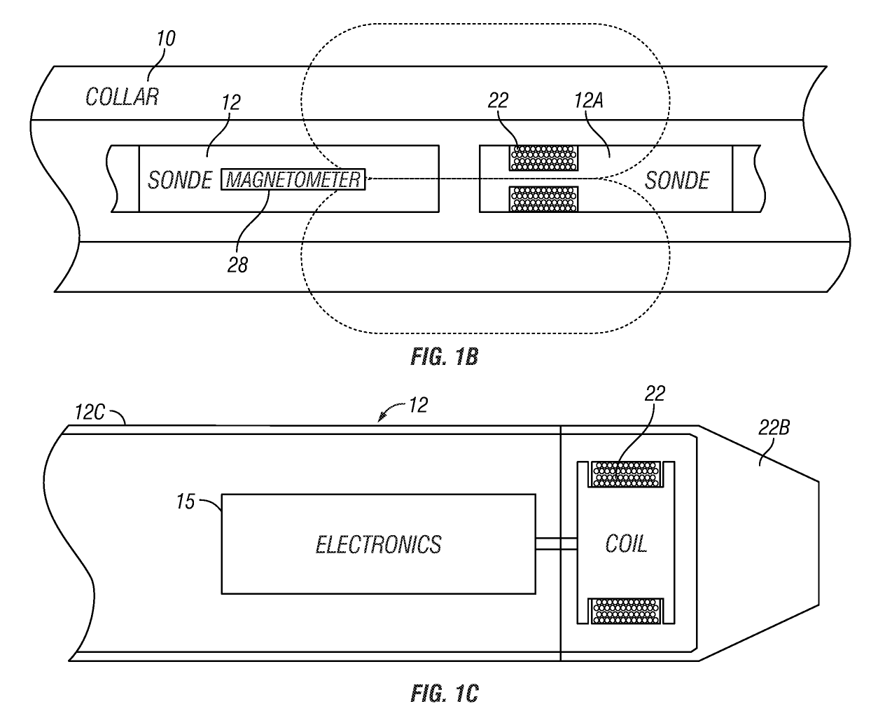

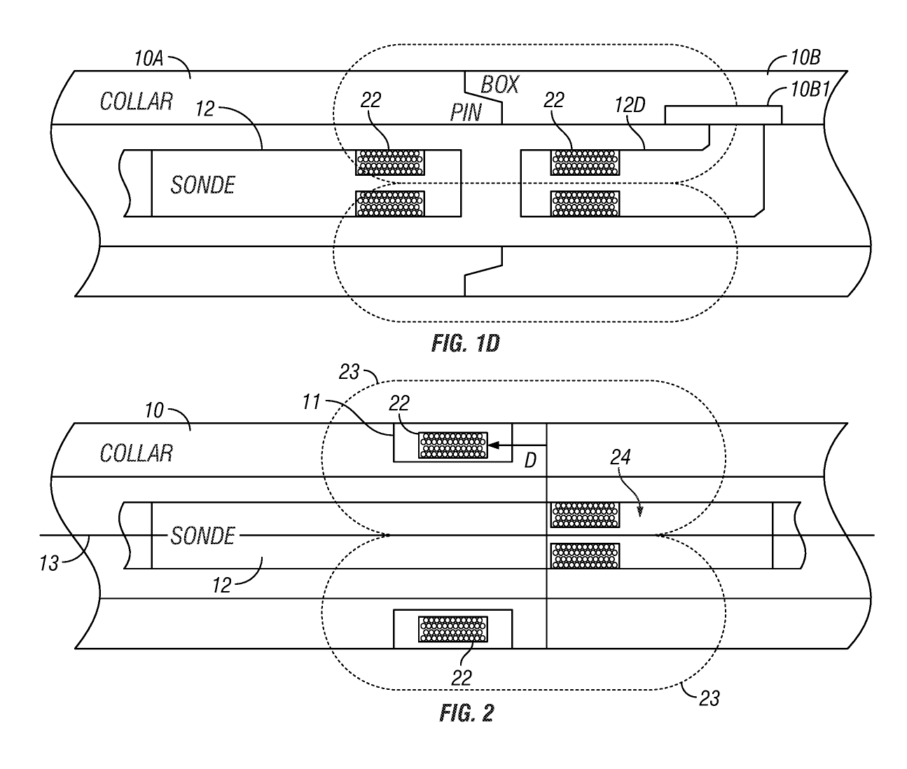

FIG. 1 shows schematically the principle of electromagnetic communication between components of a wellbore measuring instrument system according to the present disclosure. One or more communication nodes 14, 16 may be disposed within the wall of a drill collar 10. Space for the communication nodes 14, 16 in the wall of the drill collar 10 may be formed, for example and without limitation by machining a space through the exterior of the wall of the drill collar 10 and covering the space with a pressure-tight cover 11A made from high strength material to form a pressure tight compartment 11 in the wall of the drill collar 10. For example, the drill collar 10 may be made from high strength, non-magnetic material such as monel, certain alloys of stainless steel or alloys sold under the trademark INCONEL, which is a registered trademark of Huntington Alloys Corp., Huntington, W. Va. If used, such a cover may be made from a similar material. In some embodiments, the compartment 11 may be made by machining from within an interior passage 10A within the interior of the drill collar 10.

One or more “sondes”, shown in FIG. 1 at 12A and 12B may comprise a tubular housing that is pressure sealed at each longitudinal end and formed from a similar material, a different material or the same material as the drill collar 10. The sonde 12 and its sealed longitudinal ends may define a pressure-tight interior space suitable for additional communication nodes, e.g., at 18 and 20. The sonde 12A, 12B may be disposed in the interior passage 10A (show as usually centered in the drill collar 10 but not so limited). In the present context, the term “node” is intended to mean an electromagnetic transmitter antenna, an electromagnetic receiver antenna or a transceiver antenna, and associated operating circuitry, shown generally at 18A. The operating circuitry 18A may be associated with or connected to one or more sensors 19 disposed in, at, on or proximate any or all of the nodes 12A, 12B, 18 and 20. Signal communication between any or all of the nodes may enable communication of measurements made by any of the sensors 19 to a part of a sonde or a part of a drill collar wherein may be disposed a device (not shown) for storing measurements made by the various sensors (e.g., solid state memory) and/or for communicating some of such measurements to the surface using known wellbore to surface communication devices, e.g. and without limitation, drilling mud flow modulation.

FIG. 1A shows two antennas 22, 22A each disposed in a respective sonde 12, 12A. The antennas 22, 22A may be coils wound about a common axis 13, and such antennas 22, 22A and may be separated by a longitudinal distance D such that an electromagnetic field emitted by one of the two antennas 22, 22A is within the sensitive region of the other antenna 22A, 22 to enable electromagnetic signal communication between the antennas 22, 22A. In the embodiment shown in FIG. 1A, either antenna 22, 22A may perform either or both the functions of transmitter and receiver, the illustration being provided only to show the longitudinal distance between the antennas 22, 22A to effect the required electromagnetic communication between them.

FIG. 1B shows another example embodiment in which two sondes 12, 12A are disposed proximate each other inside a collar 10 (or more than one collar, e.g., adjacent collars in a drilling tool string). In the example embodiment of FIG. 1B, one sonde 12A comprises a coil 22 which may be used as a transmitter antenna. The other sonde 12 may comprise a magnetometer 28 which may be used as an electromagnetic receiver.

FIG. 1C shows another embodiment of a sonde 12, wherein the sonde 12 comprises a pressure tight housing, enclosure or barrel 12C which may be made from electrically conductive metal as in the previously described embodiments. Electronic circuitry 15 used to provide signals to an antenna coil 22 and/or receive signals from the antenna coil 22 may be disposed inside the pressure tight barrel 12C. The antenna coil 22 may be disposed longitudinally beyond an end of the pressure tight barrel 12C inside an antenna cover 22B. The antenna cover 22B may be partially conically shaped to reduce erosion wear on the antenna cover 22B when fluid, e.g., drilling fluid, is pumped through the collar (10 in FIG. 1B). The antenna cover 22B may be made from electrically conductive metal for pressure resistance, but may also be made from materials such as plastic, ceramic and various resins such as polymer resin or epoxy resin. It will be appreciated that the shape and thickness and type of the materials used for the antenna cover 22B may be selected to provide pressure resistance so that fluid under pressure is excluded from entering the pressure tight barrel 12C. The embodiment in FIG. 1C may be used for sonde to sonde communication or sonde to collar communication, the latter being possible if a communication node such as shown at 14 in FIG. 1 is disposed in the wall of the collar.

FIG. 1D shows another embodiment of a communication system that has a sonde 12 with an antenna coil 22 as described with reference to FIGS. 1A and 1B disposed inside a first collar 10A. A crossover sonde 12D may be disposed in a second collar 10B threadedly connected to the first collar 10A. The crossover sonde 12D may provide a pressure tight enclosure that is sealingly connected to a corresponding pressure sealed chamber or compartment 10B1 in the second collar 10B. The embodiment shown in FIG. 1D may be used to communicate between a sonde and a collar across a threaded connection between adjacent collars, e.g., first and second collars 10A, 10B so as to reduce wear caused by erosion at the connection interface, where erosion could be caused by flow of fluid, e.g., drilling fluid, through the first and second collars 10A, 10B.

FIG. 2 shows an example embodiment of a transceiver antenna 22 disposed in a compartment 11 in the drill collar 10. The transceiver antenna 22 may comprise a coil wound about the longitudinal axis 11 of the drill collar 10 wherein the coil windings are substantially in planes perpendicular to the longitudinal axis 13 and are substantially coaxial with the longitudinal axis 13. Field lines for the magnetic component of an electromagnetic field are shown at 23. The electromagnetic field from the transceiver antenna 22 (in FIG. 2 operating as an electromagnetic transmitter) pass through a transceiver antenna 24 disposed in a sonde 12 located in the drill collar 10. FIG. 2 illustrates the principle that the transceiver antenna 22 disposed in the collar 10 and the transceiver antenna 24 disposed in the sonde 12 may be longitudinally displaced from each other by a selected distance D and still provide signal communication between the antennas 22, 24.

FIG. 3 shows another example embodiment similar in principle to the embodiment shown in FIG. 2, but wherein the transceiver antenna 26 in the compartment 11 in the drill collar 10 is formed as a solenoid with coils wound in planes perpendicular to the longitudinal axis (13 in FIG. 2). The magnetic component field lines are shown at 23 in FIG. 3 and may be characterized as generally being symmetric about the transceiver antenna 26, but generally disposed in the compartment 11 on one side of the drill collar 10, in contrast to the field lines in FIG. 2 which are symmetric about the longitudinal axis (13 in FIG. 2) of the collar 10.

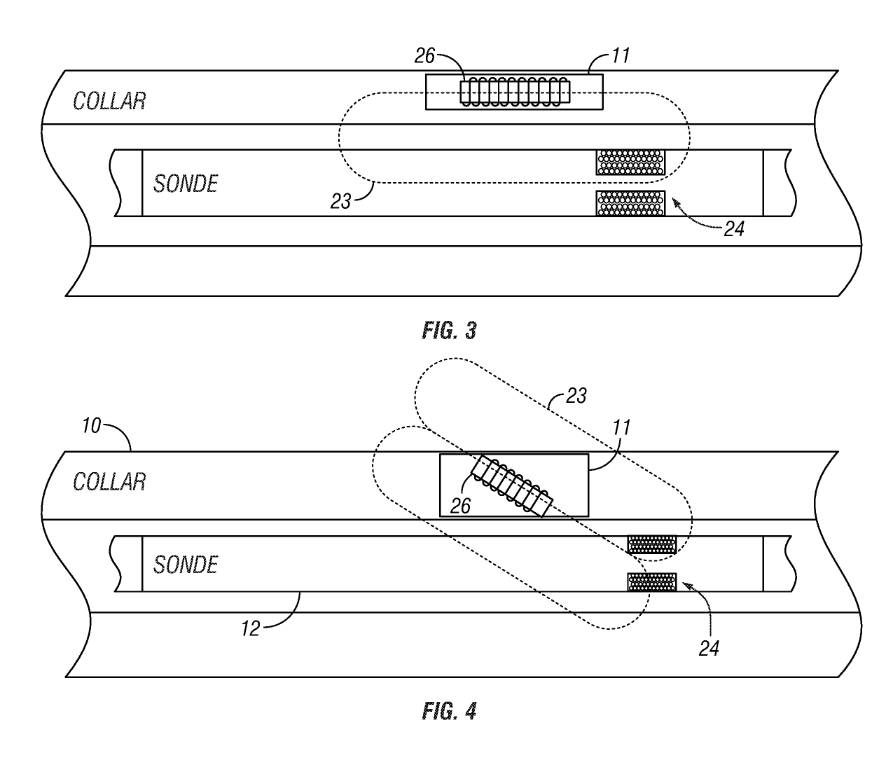

FIG. 4 shows another example embodiment similar to the embodiment of FIG. 3, wherein the transceiver antenna 26 in the drill collar 10 is disposed at an oblique angle with respect to the longitudinal axis (11 in FIG. 2). A possible advantage of the embodiment shown in FIG. 4 is that the transceiver antenna 26 in the compartment 11 in the drill collar 10 and the transceiver antenna 24 in the sonde 12 may be separated from each other by a larger longitudinal distance than that described with reference to the embodiments shown in FIG. 2 and FIG. 3 while maintaining electromagnetic signal communication between the antennas 24, 26.

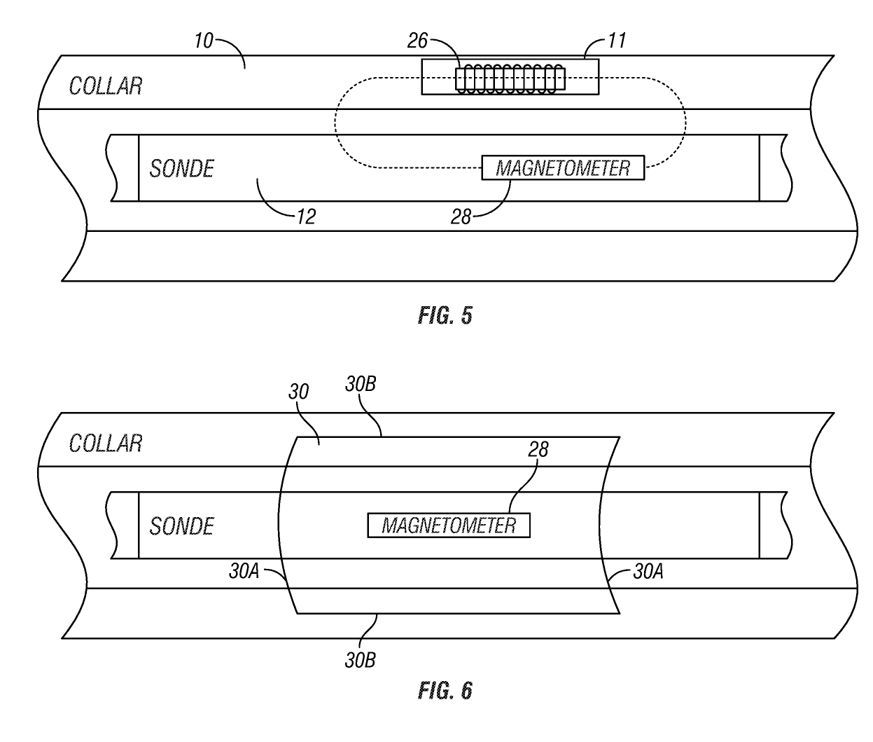

FIG. 5 shows another example embodiment wherein the transceiver antenna in the sonde 12 may be substituted by a magnetometer 28. A transmitter antenna 26 may be disposed in the compartment 11 in the drill collar 10. The transmitter antenna 26 may be configured similarly to the transceiver antenna shown in and explained with reference to FIG. 3. It will be appreciated by those skilled in the art that electromagnetic communication using an embodiment such as shown in FIG. 5 can only take place in one direction, i.e., from the transmitter antenna 26 to the magnetometer 28. In some embodiments, the positions of the transmitter antenna and the magnetometer may be reversed in order to enable communication from the sonde 12 to the drill collar 10. In some embodiments, a magnetometer may be disposed in both the drill collar 10 and the sonde 12, and a corresponding transmitter antenna may be disposed in the drill collar 10 to enable two-way communication. The magnetic dipole orientation of the transmitter antenna 26 and the sensitive axis of the magnetometer 28 may be along any selected direction provided that the magnetic field component of the signal produced by the transmitter antenna 26 is at least in part along the sensitive direction of the magnetometer 28.

In another embodiment shown in FIG. 6, the transmitter antenna may be in the form of a “saddle coil” 30, which may be configured as a wire loop having sides 30A that substantially conform to the curvature of the drill collar 10 and longitudinal segments 30B having length selected such that the saddle coil 30 encloses a selected area. The sonde 12 may comprise a magnetometer 28 as shown in FIG. 6, or may comprise another antenna of types shown in and explained with reference to FIGS. 2 and 3.

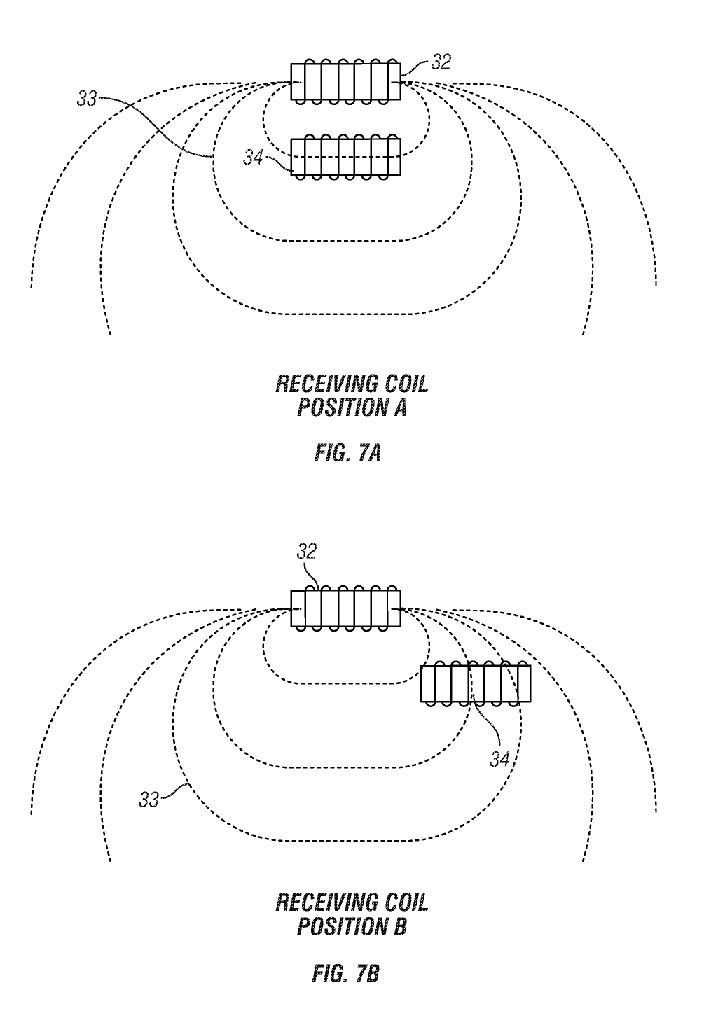

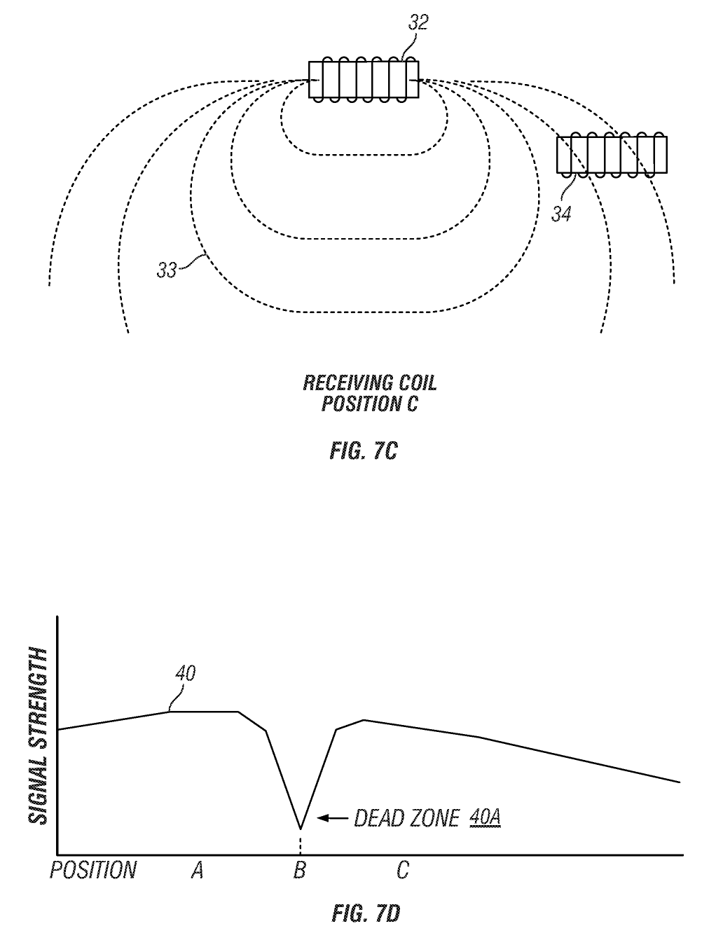

FIGS. 7A, 7B and 7C illustrate graphically that the longitudinal separation between a first transceiver antenna 32 and a second transceiver antenna 34 may affect the degree of signal coupling between them. In the example shown in FIGS. 7A, 7B and 7C, the antennas 32, 34 may be in the form of solenoid coils such as shown in and explained with reference to FIG. 2. When the antennas 32, 34 are at a same longitudinal position with respect to each other, as shown in FIG. 7A, the magnetic component field lines 33 are such that there is substantial signal coupling between the antennas 32, 34. A graph of response of the antennas 32, 34 is shown at curve 40 in FIG. 7D at position A. When the antennas 32, 34 are separated by a particular longitudinal distance, as shown in FIG. 7B, the magnetic component field lines from one antenna 32 are perpendicular to the longitudinal magnetic dipole moment of the other antenna 34. At such distance, and as shown at curve 40 in FIG. 7D at Position B, there is substantially no signal coupling between the antennas 32, 34. Such distance may be referred to as a “dead zone.” Further separation of the antennas 32, 34 as shown in FIG. 7C may result in restored signal coupling between antennas 32, 34 as shown by curve 40 in FIG. 7D at Position C.

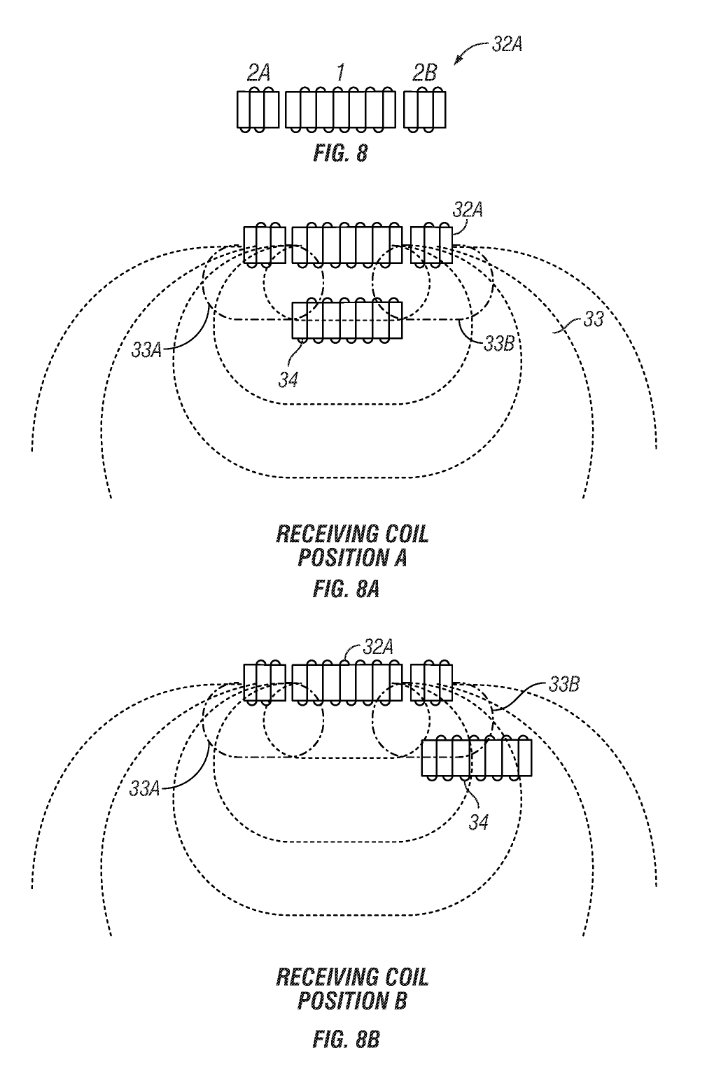

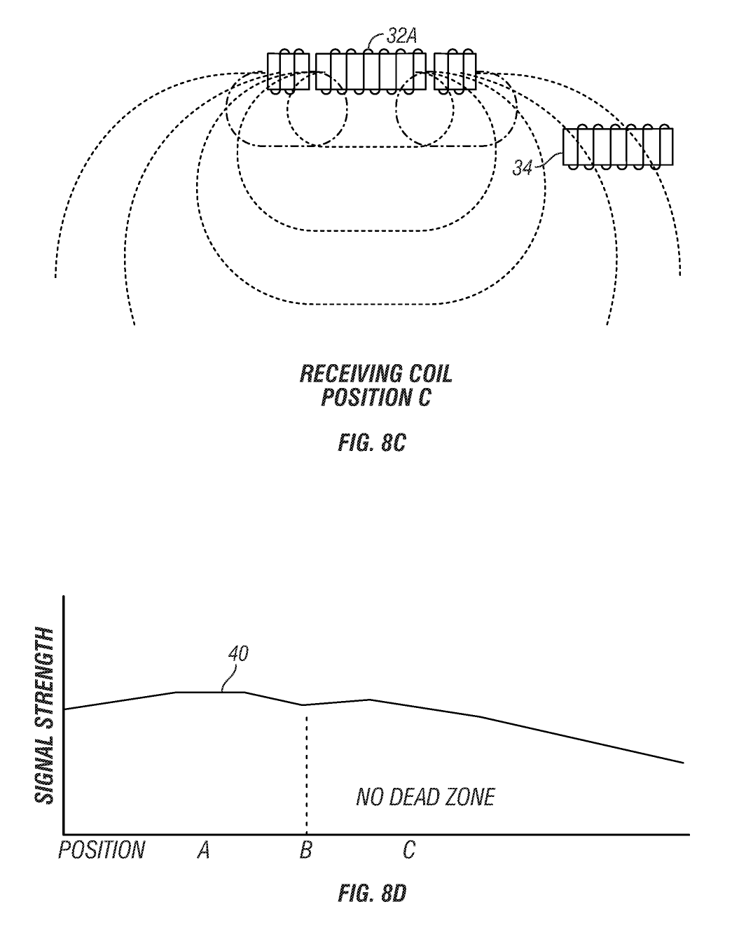

FIG. 8 shows one example embodiment of a transceiver antenna arrangement that can substantially eliminate the dead zone. The first transceiver antenna is shown at 32A and in this embodiment may comprise a main coil 1 and two longitudinal end coils 2A, 2B. The magnetic component field lines from the main coil 1 are shown at 33 in FIGS. 8A, 8B and 8C. The magnetic component field lines are shown for each of the longitudinal end coils 2A, 2B at 33A and 33B, respectively, in each of FIGS. 8A, 8B and 8C. When the two antennas 32A, 34 are longitudinally coincident as shown in FIG. 8A and correspondingly at Position A in FIG. 8D, the main coil 1 is in primary electromagnetic communication with the antenna 34. When the longitudinal position of the antennas 32A, 34 is as shown in FIG. 8B and at Position B in FIG. 8D, which in the embodiment shown in FIG. 7C is in the “dead zone”, the magnetic component field lines from one of the longitudinal end coils 2B provides signal communication between such longitudinal end coil 2B and the antenna 34. As the longitudinal spacing between the antennas 32A, 34 increases, signal communication between the main coil 1 and the antenna 34 may increase in amplitude as shown in the graph at 40. In the graph at 40 it may be observed that the dead zone shown in FIG. 7D has been substantially eliminated. Thus, a configuration of antennas as shown in FIG. 8 may enable a larger range of longitudinal separation between the antennas 32A, 34 than when using only a single solenoid coil for both antennas (as shown in FIG. 7).

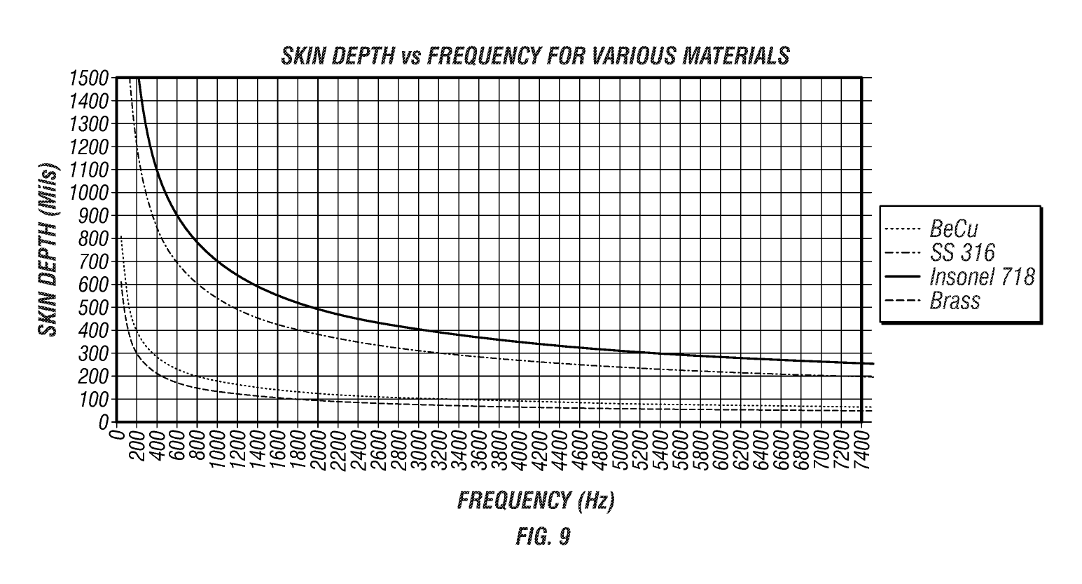

The longitudinal end coils 2A, 2B may be driven at a different frequency and/or at different times relative to the main coil 1. For example, if a chosen center frequency for a selected embodiment is Fo, then the main coil 1 may be driven at Fo+Fd, where Fd represents a frequency difference related to the selectivity of receiver circuitry connected to the antenna 34. In such embodiment, the longitudinal end coils 2A, 2B may be driven at Fo−Fd. The frequency Fo+/−Fd may be chosen to provide adequate signal coupling between the coils 1, 2A, 2B and the antenna 34 (with some minor attenuation). Adequate coupling is explained below with reference to FIG. 9. Some embodiments may use the same frequency Fo or frequency range Fo+/−Fd as above, but switch transmitter current between the main coil 1 and the longitudinal end coils 2A, 2B to avoid substantial attenuation and/or corruption due to waveform super-position of simultaneously transmitted signals through all three coils 1, 2A, 2B.

Various embodiments as shown in and explained with reference to FIGS. 1 through 8 may provide communication between antennas that do not require the antennas to be at the same longitudinal position with respect to each other. The foregoing property of embodiments made according to the present disclosure may reduce the need for design of electromagnetic communication components which have precise longitudinal and axial alignment, thus enabling more tolerance in assembly, in ability to recut threads on collars and in design of centralizing devices that retain sondes inside collars.

FIG. 9 shows a graph of skin depth with respect to frequency for various electrically conductive materials that may be used for the drill collar (10 in FIG. 2) and the sonde (12 in FIG. 2). The material selected may be that which provides sufficient skin depth at a selected frequency such that electromagnetic communication may take place between antennas as explained with reference to the various embodiments in FIGS. 1 through 8 while the wall thickness of the material is selected to provide sufficient mechanical strength to withstand both the mechanical stresses resulting from drilling (e.g., for the drill collar) as well as the fluid pressure expected at the deepest point in a wellbore. A non-limiting example of wall thickness is that required to withstand fluid pressure of 20,000 pounds per square inch. In such embodiments, the material selected and the frequency selected should be those which provide an adequate ratio of skin depth to wall thickness such that electromagnetic signal is detectable between any two antennas, in particular but not limiting, within a drill collar wall and within a sonde. Example materials that may be used in some embodiments include stainless steel alloy 316 and INCONEL brand alloy 718.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. An electromagnetic communication system for a wellbore instrument, comprising:
at least a first antenna disposed in a pressure tight compartment in a wall of a drill collar or in a pressure tight sonde disposed in an interior passage in the drill collar; and
at least a second antenna disposed in a pressure tight sonde disposed in an interior passage in the drill collar or in a pressure tight compartment in the wall of the drill collar;
wherein a wall thickness of the drill collar and/or a wall thickness of the pressure tight sonde, an electrically conductive material used for the drill collar and the pressure tight sonde and a frequency of electromagnetic signals applied to at least one of the antennas are chosen to enable electromagnetic communication between the first antenna and the second antenna.

2. The system of claim 1 wherein the first antenna and the second antenna comprise coaxially wound coils.

3. The system of claim 1 wherein the antenna in the wall of the drill collar comprises a solenoid coil disposed on one side of the drill collar.

4. The system of claim 3 wherein a longitudinal axis of the antenna in the wall of the drill collar is oriented so that a magnetic dipole moment is parallel to a longitudinal axis of the drill collar.

5. The system of claim 3 wherein a longitudinal axis of the antenna in the wall of the drill collar is oriented so that a magnetic dipole moment is at an oblique angle to a longitudinal axis of the drill collar.

6. The system of claim 3 wherein at least one of the first antenna and the second antenna comprises a main coil and a longitudinal end coil disposed at each longitudinal end of the main coil.

7. The system of claim 1 wherein one of the first antenna and the second antenna comprises a magnetometer.

8. The system of claim 1 wherein the antenna in the wall of the drill collar comprises a saddle coil.

9. The system of claim 1 wherein the sonde comprises a metal pressure barrel and an antenna cover disposed at one longitudinal end of the metal pressure barrel.

10. A method for electromagnetic communication, comprising:
conducting an electromagnetic signal to a transmitter antenna;
detecting an electromagnetic signal induced in a receiver antenna by the electromagnetic signal conducted to the first transceiver antenna; wherein
at least one of the transmitter antenna and the receiver antenna is disposed in a pressure tight compartment in a wall of a drill collar or in a pressure tight sonde; and
at least one of the receiver antenna and the transmitter antenna is disposed in a pressure tight sonde disposed in an interior passage in the drill collar or in a pressure tight compartment in a wall of the drill collar;
wherein a wall thickness of the drill collar and/or a wall thickness of the sonde, an electrically conductive material used for the drill collar and the sonde and a frequency of the electromagnetic signal conducted to the transmitter antenna are chosen to enable electromagnetic communication between the transmitter antenna and the receiver antenna.

11. The method of claim 10 wherein the antenna in the wall of the drill collar and/or the antenna in the sonde comprise coaxially wound coils.

12. The method of claim 10 wherein the antenna in the wall of the drill collar comprises a solenoid coil disposed on one side of the drill collar.

13. The method of claim 12 wherein a longitudinal axis of the antenna in the wall of the drill collar is oriented so that a magnetic dipole moment is parallel to a longitudinal axis of the drill collar.

14. The method of claim 12 wherein a longitudinal axis of the antenna in the wall of the drill collar is oriented so that a magnetic dipole moment is at an oblique angle to a longitudinal axis of the drill collar.

15. The method of claim 12 wherein at least one of the antenna in the wall of the drill collar and the antenna in the sonde comprises a main coil and a longitudinal end coil disposed at each longitudinal end of the main coil.

16. The method of claim 10 wherein the receiver antenna comprises a magnetometer.

17. The method of claim 10 wherein the antenna in the wall of the drill collar comprises a saddle coil.

18. The method of claim 10 wherein the sonde comprises a metal pressure barrel and an antenna cover disposed at one longitudinal end of the metal pressure barrel.
